(19) United States
(12) Patent Application Publication
(10) Pub. No.: US 2026/0179133 A1
(43) Pub. Date: Jun. 25, 2026

(54) SEARCH CONTROL SYSTEM, SEARCH CONTROL METHOD, AND INFORMATION STORAGE MEDIUM

(71) Applicant: Rakuten Group, Inc., Tokyo (JP)

(72) Inventors: Yilin LI, Singapore (SG); Fan XU, Singapore (SG); Tingxi WU, Singapore (SG); Guangda LI, Singapore (SG); Ting CAI, Tokyo (JP)

(21) Appl. No.: 19/258,917

(22) Filed: Jul. 3, 2025

(30) Foreign Application Priority Data
Dec. 24, 2024 (JP) 2024-228019

(51) Int. Cl. G06Q 30/0601; G06F 16/242; G06F 16/248

(52) U.S. Cl. CPC G06Q 30/0625; G06F 16/248; G06F 16/243

(57) ABSTRACT

A search intermediation module determines, based on a given search query and a history of a query, for each of a plurality of search systems, used for a search executed by this search system, at least one target system from the plurality of search systems. The search intermediation module outputs the search query to each of the at least one target system. The search intermediation module receives a search result in response to the search query from each of the at least one target system. A display control module displays a screen showing the search result received from each of the at least one target system.

### CROSS-REFERENCE TO RELATED APPLICATIONS

The present application claims priority from Japanese application JP2024-228019 filed on Dec. 24, 2024, the content of which is hereby incorporated by reference into this application.

### BACKGROUND OF THE INVENTION

### 1. Field of the Invention

The present invention relates to a search control system, a search control method, and an information storage medium.

### 2. Description of the Related Art

In Japanese Patent Application Laid-open No. 2011-133926, there is described a technology which supports a product search executed by a user in a shopping site on the Internet.

### SUMMARY OF THE INVENTION

In recent years, there have been various search systems, and it is difficult for a user to determine a search system suitable for a desired search from those search systems.

The present invention has been made in view of the above-mentioned problem, and has an object to provide a search control system, a search control method, and an information storage medium which enable a user to acquire a search result obtained by a search system suitable for a desired search without paying attention to existence of a plurality of search systems.

A search control system according to at least one embodiment of the present invention includes: target system determination means for determining, based on a given search query and a history of a query used for a search executed by each of a plurality of search systems, at least one target system from the plurality of search systems; search query output means for outputting the given search query to each of the at least one target system; search result reception means for receiving a search result in response to the given search query from the each of the at least one target system; and display control means for displaying a screen showing the search result received from the each of the at least one target system.

A search control method according to at least one embodiment of the present invention includes: determining, based on a given search query and a history of a query used for a search executed by each of a plurality of search systems, at least one target system from the plurality of search systems; outputting the given search query to each of the at least one target system; receiving a search result in response to the given search query from the each of the at least one target system; and displaying a screen showing the search result received from the each of the at least one target system.

An information storage medium according to at least one embodiment of the present invention is an information storage medium storing a program that causes a computer to execute: determining, based on a given search query and a history of a query used for a search executed by each of a plurality of search systems, at least one target system from the plurality of search systems; outputting the given search query to each of the at least one target system; receiving a search result in response to the given search query from the each of the at least one target system; and displaying a screen showing the search result received from the each of the at least one target system.

### BRIEF DESCRIPTION OF THE DRAWINGS

FIG. 1 is a diagram for illustrating an example of a configuration of a chat system in at least one embodiment of the present invention.

FIG. 2 is a view for illustrating an example of a chat screen.

FIG. 3 is a view for illustrating an example of the chat screen.

FIG. 4 is a view for illustrating an example of a search result screen.

FIG. 5 is a view for illustrating an example of the search result screen.

FIG. 6 is a view for illustrating an example of the search result screen.

FIG. 7 is a functional block diagram for illustrating an example of functions of a search control system according to the at least one embodiment of the present invention.

FIG. 8A is a flowchart for illustrating an example of a flow of processing executed in the search control system according to the at least one embodiment of the present invention.

FIG. 8B is a flowchart for illustrating the example of the flow of the processing executed in the search control system according to the at least one embodiment of the present invention.

FIG. 8C is a flowchart for illustrating the example of the flow of the processing executed in the search control system according to the at least one embodiment of the present invention.

FIG. 9 is a flowchart for illustrating an example of a flow of processing executed in the search control system according to the at least one embodiment of the present invention.

### DETAILED DESCRIPTION OF THE INVENTION

Now, description is given in detail of at least one embodiment of the present invention with reference to the drawings.

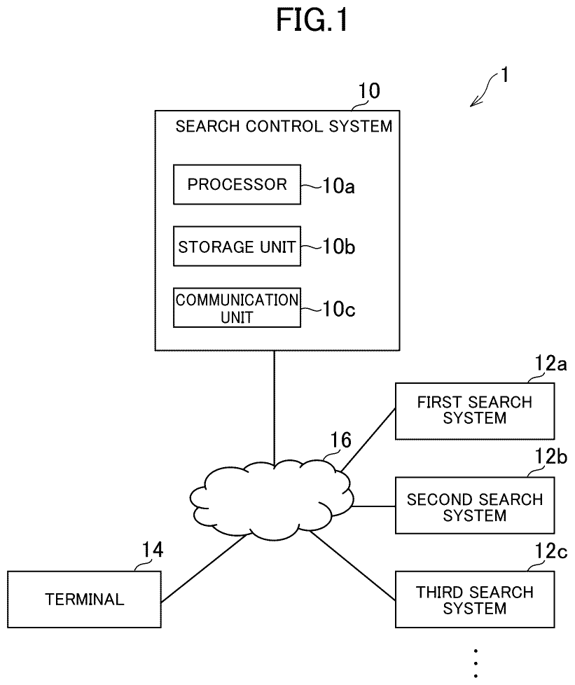

FIG. 1 is a diagram for illustrating an example of a configuration of a chat system 1 in at least one embodiment of the present invention. As illustrated in FIG. 1, the chat system 1 in the at least one embodiment includes a search control system 10, search systems 12 (a first search system 12a, a second search system 12b, a third search system 12c, . . . ), and a terminal 14. The search control system 10, the search systems 12, and the terminal 14 are connected to a computer network 16 such as the Internet.

The search control system 10 may be formed of a computer, for example, a server computer. The search control system 10 may include a processor 10a such as a CPU or a GPU, a storage unit 10b such as a memory or a hard disk drive, and a communication unit 10c such as a network interface card. The search control system 10 may include a plurality of computers or one computer.

Each of the search systems 12 may be formed of a server computer including, for example, a CPU, a GPU, a memory, and a communication interface. Moreover, the search system 12 may include a plurality of computers or one computer.

The terminal 14 may be formed of a computer (for example, a personal computer, a smartphone, or a tablet terminal) including, for example, a CPU, a memory, a communication interface, an input device, and a display.

In the at least one embodiment, for example, a chat message is exchanged between the search control system 10 and the terminal 14. In this exchange, a search in the search system 12 is appropriately executed. In the search system 12, for example, a search for suggestion to a user (more specifically, for example, a search for generating options for a product or a service the purchase of which is suggested to the user) is executed.

In the at least one embodiment, for example, search targets of a search in the respective search systems 12 are different from each other. Moreover, the search system 12 may execute a search having a product or a service as the search target. For example, the search executed by the first search system 12a may have, as the search target, data indicating products to be sold in online shopping, the search executed by the second search system 12b may have, as the search target, data indicating listed second-hand products, and the search executed by the third search system 12c may have, as the search target, data indicating books or electronic books. Moreover, for example, a search executed by another search system 12 may have, as the search target, data indicating fashion items provided by a fashion brand. Moreover, a search executed by still another search system 12 may have, as the search target, delivered music data. Moreover, a search executed by yet another search system 12 may have, as the search target, data on recipes.

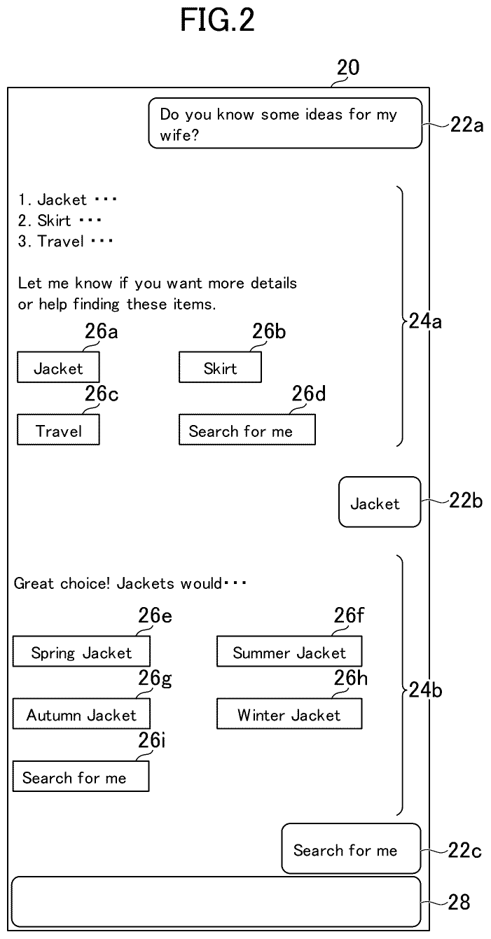

FIG. 2 is a view for illustrating an example of a chat screen 20 displayed on a display of the terminal 14 in the at least one embodiment. The chat screen 20 may be a screen which can be scrolled in a predetermined direction (for example, an up-down direction).

On the chat screen 20 illustrated in FIG. 2, user message images 22 (22a, 22b, and 22c) indicating chat messages input by the user who operates the terminal 14 are arranged.

Moreover, on the chat screen 20 illustrated in FIG. 2, answer message images 24 (24a and 24b) indicating chat messages transmitted from the search control system 10 to the terminal 14 in response to the chat messages received by the search control system 10 from the terminal 14 are arranged. Moreover, the answer message image 24 may include option images 26 which indicate options selectable by the user. In the example of FIG. 2, the answer message 24a includes an option image 26a, an option image 26b, an option image 26c, and an option image 26d. Moreover, the answer message 24b includes an option image 26e, an option image 26 f, an option image 26g, an option image 26h, and an option image 26i.

Moreover, on the chat screen 20 illustrated in FIG. 2, an input form 28 for the user to input a chat message is arranged.

When the user inputs a character string to the input form 28, and executes a predetermined operation (for example, input of an enter key or a tap operation on a send button), a chat message including the character string input to the input form 28 is transmitted from the terminal 14 to the search control system 10.

Moreover, when the user executes an operation of selecting the option image 26 (for example, a tap operation on the option image 26), a chat message including a character string arranged on the selected option image 26 is transmitted from the terminal 14 to the search control system 10.

Moreover, the chat screen 20 having an added user message image 22 including the chat message transmitted from the terminal 14 to the search control system 10 is displayed on the display of the terminal 14.

On the chat screen 20 illustrated in FIG. 2, a situation in which a chat message “Search for me” is transmitted from the terminal 14 to the search control system 10 in response to the selection operation on the option image 26i is displayed.

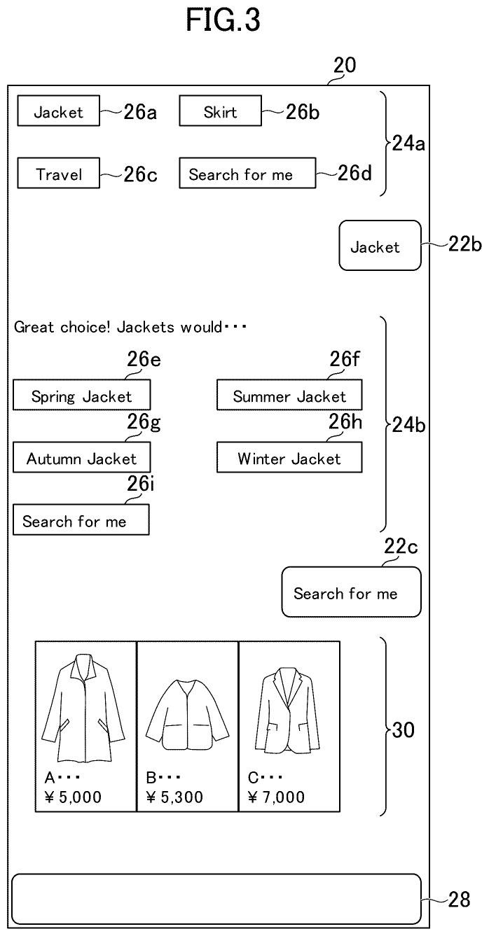

After that, in the at least one embodiment, for example, as illustrated in FIG. 3, a search result of the search executed in the search system 12 is transmitted from the search control system 10 to the terminal 14, and the chat screen 20 having an added search result overview image 30 showing this search result is displayed on the display of the terminal 14. A chat screen 20 having an added search result overview image 30 showing some of the search results in the search executed by the search system 12 may be displayed on the display of the terminal 14. As illustrated in FIG. 3, this search result may indicate a product or a service. For example, as illustrated in FIG. 3, this search result may include an image of a product or a service, a name of a product or a service, and a price of a product or a service.

Moreover, as illustrated in FIG. 3, on the display of the terminal 14, the chat screen 20 on which the chat messages and the search results are arranged in chronological order may be displayed. For example, as illustrated in FIG. 3, the chat screen 20 on which the chat messages and the search results are arranged in chronological order from the older ones from the top to the bottom may be displayed.

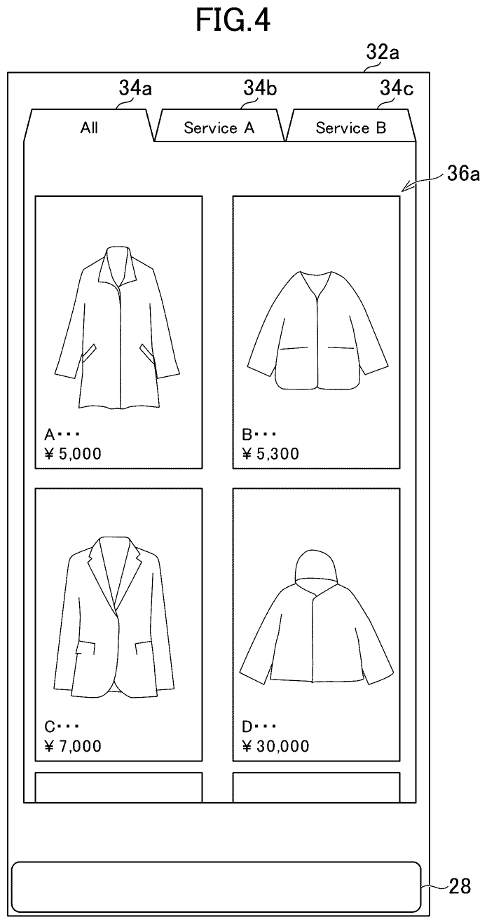

When the user executes a predetermined operation (for example, a tap operation) on the search result overview image 30 in a situation in which the chat screen 20 is displayed, a search result display request is transmitted from the terminal 14 to the search control system 10. Then, a search result screen 32 (here, for example, a search result screen 32a exemplified in FIG. 4) is displayed on the display of the terminal 14.

The search result screen 32 includes a plurality of tabs 34 and a plurality of search result detail images 36. In the example of FIG. 4, the search result screen 32 includes three tabs 34 (34a, 34b, and 34c). Moreover, in the at least one embodiment, the tab 34 and the search result detail image 36 are associated with each other in a one-to-one manner.

In the at least one embodiment, of the plurality of search result detail images 36, the search result detail image 36 associated with the tab 34 in the selected state is in a display state, and the other search result detail images 36 are in a hidden state.

On the search result screen 32a illustrated in FIG. 4, the tab 34a is in the selected state, and the tab 34b and the tab 34c are in the unselected state. Moreover, the search result detail image 36a associated with the tab 34a and showing all search results is in the display state, and the search result detail image 36b and the search result detail image 36c are in the hidden state. The search result detail image 36a may show some of all search results.

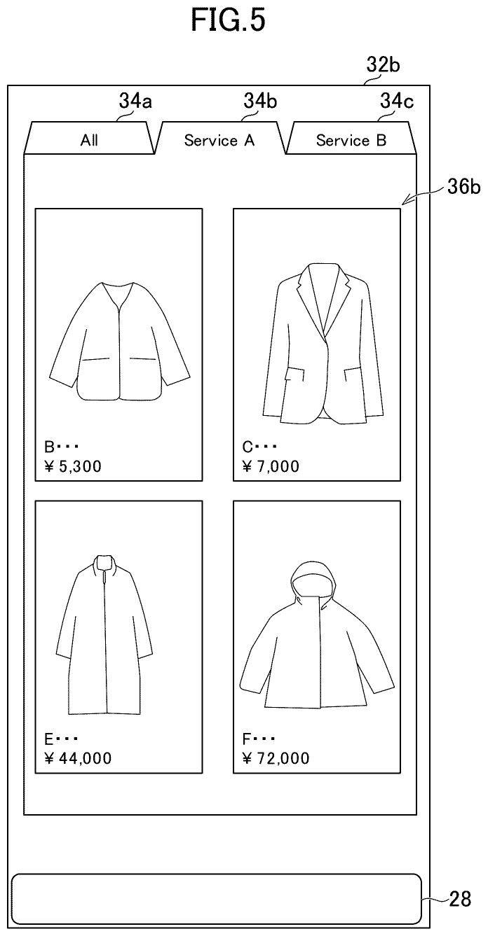

It is assumed that, in a situation in which the search result screen 32a illustrated in FIG. 4 is displayed, a predetermined operation is executed on the tab 34b. Then, the search result screen 32a displayed on the display of the terminal 14 is updated to a search result screen 32b illustrated in FIG. 5. On the search result screen 32b illustrated in FIG. 5, the tab 34b is in the selected state, and the tab 34a and the tab 34c are in the unselected state. Moreover, the search result detail image 36b associated with the tab 34b and showing the search result executed in a certain search system 12 (here, for example, the first search system 12a) is in the display state, and the search result detail image 36a and the search result detail image 36c are in the hidden state. The search result detail image 36b may show some of the search results in the search executed in the first search system 12a.

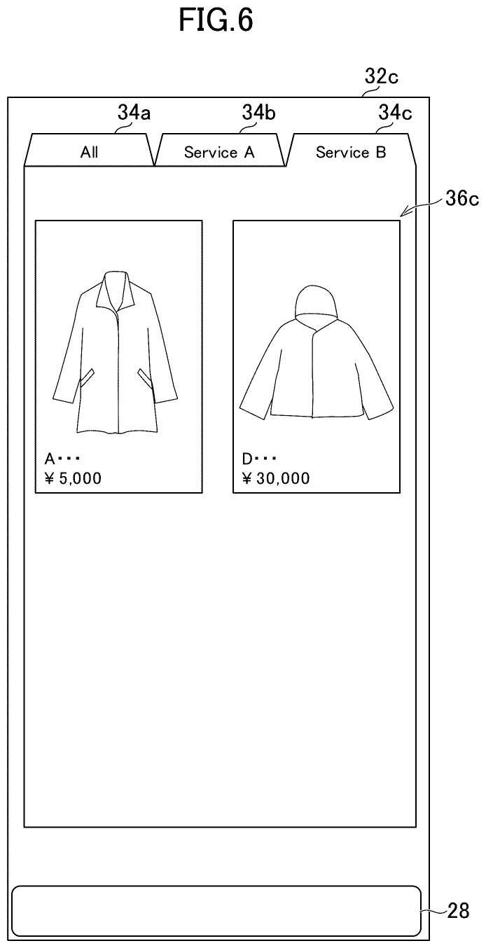

It is assumed that, in a situation in which the search result screen 32b illustrated in FIG. 5 is displayed, a predetermined operation is executed on the tab 34c. Then, the search result screen 32b displayed on the display of the terminal 14 is updated to a search result screen 32c illustrated in FIG. 6. On the search result screen 32c illustrated in FIG. 6, the tab 34c is in the selected state, and the tab 34a and the tab 34b are in the unselected state. Moreover, the search result detail image 36c associated with the tab 34c and showing the search result executed in another search system 12 (here, for example, the second search system 12b) is in the display state, and the search result detail image 36a and the search result detail image 36b are in the hidden state. The search result detail image 36c may show some of the search results in the search executed in the second search system 12b.

It is assumed that, in a situation in which the search result screen 32b illustrated in FIG. 5 or the search result screen 32c illustrated in FIG. 6 is displayed, a predetermined operation is executed on the tab 34a. Then, the search result screen 32 displayed on the display of the terminal 14 is updated to the search result screen 32a illustrated in FIG. 4.

In the at least one embodiment, for example, both of the search result in the search executed in the first search system 12a and the search result in the search executed in the second search system 12b are shown in the search result detail image 36a displayed on the search result screen 32a illustrated in FIG. 4. In the search result detail image 36a, some of the search results in the search executed in the first search system 12a shown in the search result detail image 36b and some of the search results in the search executed in the second search system 12b shown in the search result detail image 36c may be shown.

Moreover, in the at least one embodiment, for example, by the user executing a predetermined operation (for example, a tap operation) on the search result shown in the search result detail image 36, the screen displayed on the display of the terminal 14 transitions to a purchase page for purchasing the product or the service indicated by this search result. Then, the user comes to be able to purchase the product or the service via this purchase page.

As described above, in the at least one embodiment, the user can seamlessly acquire the search result obtained by the search system 12 in such a sense that the user is naturally chatting a human.

Moreover, in the at least one embodiment, the user can acquire the search result obtained by the search system 12 appropriate for a desired search without paying attention to the existence of the plurality of search systems 12.

Description is now further given of functions of the search control system 10 according to the at least one embodiment and processing executed in the search control system 10.

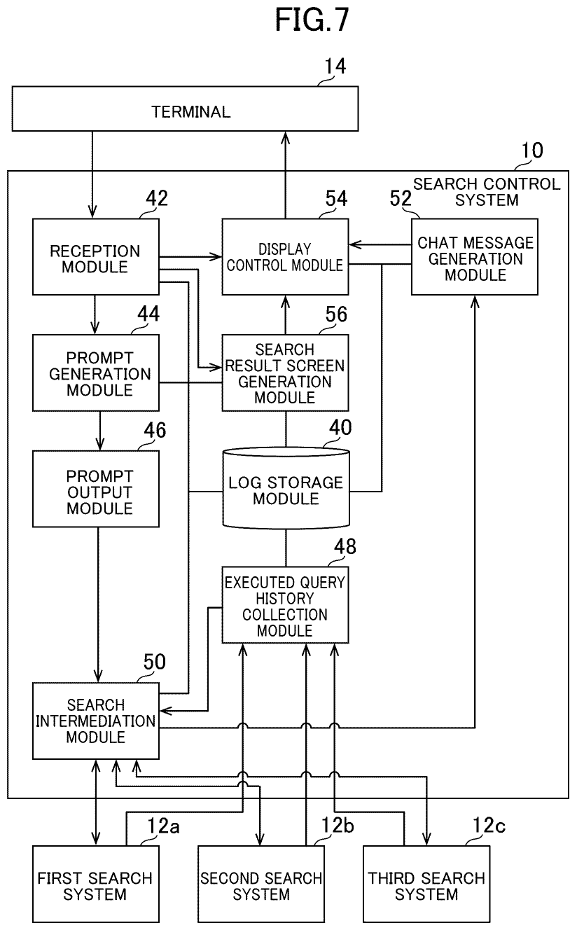

FIG. 7 is a functional block diagram for illustrating an example of functions implemented in the search control system 10 according to the at least one embodiment. In the search control system 10 according to the at least one embodiment, it is not required that all of the functions illustrated in FIG. 7 be implemented, and a function other than the functions illustrated in FIG. 7 may be implemented.

As illustrated in FIG. 7, the search control system 10 according to the at least one embodiment functionally includes, for example, a log storage module 40, a reception module 42, a prompt generation module 44, a prompt output module 46, an executed query history collection module 48, a search intermediation module 50, a chat message generation module 52, a display control module 54, and a search result screen generation module 56. The log storage module 40 is implemented mainly by the storage unit 10b. The reception module 42 and the executed query history collection module 48 are implemented mainly by the communication unit 10c. The prompt generation module 44, the prompt output module 46, the chat message generation module 52, and the search result screen generation module 56 are implemented mainly by the processor 10a. The search intermediation module 50 and the display control module 54 are implemented mainly by the processor 10a and the communication unit 10c.

The above-mentioned functions may be implemented by executing, in the search control system 10, a program installed on the search control system 10 being the computer, and including instructions corresponding to the above-mentioned functions. Moreover, this program may be supplied to the search control system 10 via a computer-readable information storage medium, for example, an optical disc, a magnetic disk, a magnetic tape, or a magneto-optical disk, or via the Internet or the like.

In the at least one embodiment, for example, the log storage module 40 stores logs related to the exchange of the chat messages between the search control system 10 and the terminal 14. For example, the log storage module 40 may store logs of the chat message received by the search control system 10 from the terminal 14 and the chat message output from the search control system 10 to the terminal 14. Here, for example, a chat message associated with a time stamp indicating a date and a time at which the chat message is received or output and a flag indicating whether this chat message is the chat message received by the search control system 10 or the chat message output by the search control system 10 may be accumulated in the log storage module 40.

In the at least one embodiment, for example, the reception module 42 receives the chat message from the terminal 14. Moreover, in the at least one embodiment, for example, the reception module 42 stores this chat message in the log storage module 40.

Moreover, in the at least one embodiment, for example, the reception module 42 receives the above-mentioned search result display request from the terminal 14.

In the at least one embodiment, for example, the prompt generation module 44 generates, based on a chat message received from the terminal 14, a prompt to be output to a language model (for example, an LLM). Here, for example, the prompt generation module 44 may generate a prompt including the chat message received by the reception module 42.

In the at least one embodiment, for example, the prompt output module 46 outputs the prompt generated by the prompt generation module 44 to the language model.

Here, the search intermediation module 50 may include a trained language model (for example, an LLM). The language model included in the search intermediation module 50 is hereinafter referred to as “intermediation LLM.”

In addition, the prompt output module 46 may output, for example, the prompt generated by the prompt generation module 44 to the intermediation LLM.

The executed query history collection module 48 collects a history of queries used in the search executed by the search system 12. Then, the executed query history collection module 48 holds the collected history of the queries.

For example, the executed query history collection module 48 may collect, at a predetermined time interval, from each of the first search system 12a, the second search system 12b, the third search system 12c, . . . , the history of the queries used in the search executed by the relevant search system 12. Moreover, the executed query history collection module 48 may collect, in response to reception of a collection instruction from the search intermediation module 50, from each of the first search system 12a, the second search system 12b, the third search system 12c, . . . , the history of the queries used in the search executed by the relevant search system 12.

Moreover, the executed query history collection module 48 may collect the history of the queries used in the search executed in response to a request from the user who uses the terminal 14 in the at least one embodiment. Moreover, the executed query history collection module 48 may collect the history of the queries used in the search executed in response to requests from a plurality of users including the user who uses the terminal 14 in the at least one embodiment. Moreover, the executed query history collection module 48 may collect the history of the queries used in the search executed in response to requests from one or more users other than the user who uses the terminal 14 in the at least one embodiment.

In the at least one embodiment, for example, the search intermediation module 50 generates an answer to the received prompt. In the at least one embodiment, it is assumed that knowledge relating to the search targets of all of the search systems 12 in the search executed in the search systems 12 is registered in advance in (learned in advance by) the intermediation LLM included in the search intermediation module 50. Moreover, in the at least one embodiment, it is assumed that the intermediation LLM can refer to the logs stored in the log storage module 40.

The search intermediation module 50 may determine, based on the logs stored in the log storage module 40, whether or not information (context) sufficient for the execution of the search by the search system 12 has been acquired.

For example, the prompt generation module 44 may generate a prompt including a template “Refer to a log at the following location to determine whether or not a search can be executed” and a character string indicating the location (for example, the URL) of the log storage module 40.

Moreover, the prompt output module 46 may output this prompt to the intermediation LLM. Then, when the answer output from the intermediation LLM in response to this prompt is a positive answer (for example, “Possible.”), the search intermediation module 50 may determine that the information (context) sufficient for the execution of the search by the search system 12 has been acquired.

Moreover, for example, the search intermediation module 50 may determine whether or not, from the logs stored in the log storage module 40, at least one predetermined attribute (for example, the gender, the age group, the address, hobby, and the number of persons in household) can be extracted. Then, when it is determined that the extraction is possible, the search intermediation module 50 may determine that the information (context) sufficient for the execution of the search by the search system 12 has been acquired.

Then, as described later, when it is determined that the information (context) sufficient for the execution of the search by the search system 12 has been acquired, a predetermined chat message (for example, a chat message including the option image 26i on which a character string “Search for me” is arranged) indicating that the search is executable may be transmitted to the terminal 14.

Moreover, in the at least one embodiment, for example, the search intermediation module 50 may generate a search query based on the log related to the exchange of the chat messages between the search control system 10 and the terminal 14. This search query may be a keyword to be used in the search for a product or a service. Here, for example, the search intermediation module 50 may generate the search query in response to satisfaction of a predetermined search execution condition. The search execution condition may be, for example, a condition that a predetermined character string (for example, “Search for me”) is included in the chat message received by the reception module 42. This predetermined character string is not required to be the character string “Search for me,” “ [symbol] (Search for . . . )” and may be a character string, for example, in Japanese. Moreover, the search execution condition may be a condition that it is determined that the information (context) sufficient for the execution of the search by the search system 12 has been acquired.

Here, the prompt generation module 44 may generate a search query generation prompt which gives an instruction to generate the search query based on the logs stored in the log storage module 40 in response to, for example, the chat message received by the reception module 42 satisfying the predetermined search execution condition, and the prompt output module 46 may output this search query generation prompt to the language model (here, for example, the intermediation LLM). Then, the search intermediation module 50 may generate the search query based on the answer output from the intermediation LLM in response to the output of the search query generation prompt to the intermediation LLM.

For example, the prompt generation module 44 may generate a prompt including a template “Refer to a log at the following location to generate a keyword group in Japanese appropriate for a search as one sentence” and a character string indicating the location (for example, the URL) of the log storage module 40, and the prompt output module 46 may output this prompt to the intermediation LLM. As another example, the prompt generation module 44 may generate a prompt including content of a log to be referred to and an instruction to generate a search query, and the prompt output module 46 may output this prompt to the intermediation LLM. Then, the search intermediation module 50 may acquire, as the search query, the answer output from the intermediation LLM in response to this prompt.

The search intermediation module 50 may generate the search query based on the chat message received from the terminal 14 (for example, the latest chat message received from the terminal 14).

The search query generated by the search intermediation module 50 is hereinafter referred to as “generated search query.”

Moreover, in the at least one embodiment, for example, the search intermediation module 50 calculates, based on a given search query (for example, the generated search query) and the history of the queries, for each of the plurality of search systems 12, used for the search executed by this search system 12, a search frequency score of each of the plurality of search systems 12.

Here, for example, the search intermediation module 50 may calculate, based on the given search query and the history of the queries held by the executed query history collection module 48, the search frequency score of each of the plurality of search systems 12.

Moreover, for example, the search intermediation module 50 may output a collection instruction to the executed query history collection module 48 in response to the generation of the generated search query. Then, the executed query history collection module 48 may collect, in response to the reception of this collection instruction, from each of the plurality of search systems 12, the history of the queries used in the search executed by this search system 12. After that, the search frequency score of each of the plurality of search systems 12 may be calculated based on the generated search query and the history of the queries collected in the manner described above.

Here, the search intermediation module 50 may calculate, for each of the plurality of search systems 12, based on the number of times of use of a given search query for the search executed by this search system 12, the search frequency score of this search system 12. For example, the search intermediation module 50 may calculate the number of times of the execution of a search that uses the same query as the generated search query in the search system 12 as the search frequency score of this search system 12. As another example, the search intermediation module 50 may calculate the number of times of the execution of a search that uses a query including the same word as any one of words included in the generated search query in the search system 12 as the search frequency score of this search system 12.

Moreover, the search intermediation module 50 may calculate, for each of the plurality of search systems 12, based on a ratio of the number of times of the execution of a search that uses a given search query to a total number of searches executed by this search system 12, the search frequency score of this search system 12. For example, the search intermediation module 50 may calculate a value obtained by dividing the number of times of the execution of the search that uses the same query as the generated search query in the search system 12 by a total number of searches executed by this search system 12 as the search frequency score of this search system 12. As another example, the search intermediation module 50 may calculate a value obtained by dividing the number of times of the execution of the search that uses the query including the same word as any one of the words included in the generated search query in the search system 12 by the total number of searches executed by this search system 12 as the search frequency score of this search system 12.

Moreover, in the at least one embodiment, the search frequency score may be normalized. For example, the frequency score calculated for each of the plurality of search systems 12 as described above may be treated as a preliminary score. Then, a value multiplied by a predetermined value so that a sum of the preliminary scores of the plurality of search systems 12 is one may be calculated as the search frequency score.

Moreover, the history of the queries used for the calculation of the search frequency score may be the history of queries used for the search executed in response to the request from a single user who uses the terminal 14. Moreover, the history of the queries used for the calculation of the search frequency score may be the history of queries used for the search executed in response to the request from each of a plurality of users including the user using the terminal 14. Moreover, the history of the queries used for the calculation of the search frequency score may be the history of queries used for the search executed in response to the request from each of one or more users other than the user using the terminal 14.

Then, in the at least one embodiment, for example, the search intermediation module 50 determines, based on the given search query and the history of the queries, for each of the plurality of search systems 12, used for the search executed by this search system 12, at least one target system from the plurality of search systems 12.

Here, the search intermediation module 50 may determine at least one target system based on the search frequency score. For example, the search system 12 having the largest value of the search frequency score may be determined as the target system. As another example, N search systems 12 having down to the Nth largest value of the search frequency score may be determined as the target systems (N is a predetermined number equal to or more than 2).

Moreover, the search intermediation module 50 may determine the search system 12 each having the search frequency score larger than a predetermined value (for example, 0.6) as the target system.

Further, in the at least one embodiment, for example, the search intermediation module 50 outputs a given search query to each of the at least one target system. Here, the search intermediation module 50 may output the generated search query to each of the at least one target system. In the at least one embodiment, the same search query is output to each of the at least one target system. Then, in the at least one embodiment, for example, the search intermediation module 50 receives a search result in response to the search query from each of the at least one target system. For example, the search intermediation module 50 receives a search result output from each of the at least one target system in response to the output of the search query to this target system.

In the at least one embodiment, when the search has been executed in the search system 12, the prompt generation module 44 may generate a prompt including the search result in the search in each of the at least one target system, and the prompt output module 46 may output this prompt to the language model (here, for example, the intermediation LLM). This prompt may include the chat message received by the reception module 42. Moreover, this prompt may include an instruction to refer to the logs stored in the log storage module 40. Moreover, the search intermediation module 50 may acquire the answer output from this language model in response to this prompt.

Meanwhile, when the search has not been executed in the search system 12, the prompt generation module 44 may generate a prompt including the chat message received by the reception module 42, and the prompt output module 46 may output this prompt to the language model (here, for example, the intermediation LLM). This prompt may include an instruction to refer to the logs stored in the log storage module 40. Moreover, the search intermediation module 50 may acquire the answer output from this language model in response to this prompt.

In the at least one embodiment, for example, the chat message generation module 52 generates the chat message to be output to the terminal 14.

For example, the chat message generation module 52 may generate a chat message including the answer generated by the intermediation LLM. Here, when the search intermediation module 50 receives the search result output from each of the at least one target system, the search intermediation module 50 may generate a chat message including the search result received from each of the at least one target system and the answer generated by the intermediation LLM.

Moreover, in the at least one embodiment, the chat message generation module 52 may generate a predetermined chat message indicating that the search is executable in response to satisfaction of a given search executability condition. For example, the chat message generation module 52 may generate a chat message including the option image 26i on which the character string “Search for me” is arranged in response to the satisfaction of the given search executability condition. Here, the search executability condition may be, for example, a condition that it is determined that the information (context) sufficient for the execution of the search has been acquired.

Moreover, a prompt including an instruction to generate options to be presented to the user may be output to the intermediation LLM. Moreover, the chat message generation module 52 may generate a chat message including an option image 26 associated with each of one or more options output from the intermediation LLM in response to the output of this prompt.

In the at least one embodiment, for example, the display control module 54 displays the chat screen 20 on the display of the terminal 14.

The display control module 54 may generate, for example, in response to the reception of the chat message from the terminal 14 by the reception module 42, the chat screen 20 to which this chat message is added, and may transmit this chat screen 20 to the terminal 14. Then, the terminal 14 may display, in response to the reception of this chat screen 20, this chat screen 20 on the display of the terminal 14.

Moreover, for example, the display control module 54 may generate, in response to the chat message generation module 52 generating the chat message, the chat screen 20 to which this chat message is added, and may output this chat screen 20 to the terminal 14. Here, this chat message may include the search result (for example, the search result overview image 30) received from each of the at least one target system. This chat message may include some of the search results received from each of the at least one target system (for example, the search result overview image 30 showing some of the search results received from the search system 12). Then, the terminal 14 may display, in response to the reception of this chat screen 20, this chat screen 20 on the display of the terminal 14.

As described above, the display control module 54 in the at least one embodiment plays a role of a chat message output module which outputs, to the terminal 14, the chat message based on the answer from the language model in response to the prompt. Moreover, the display control module 54 in the at least one embodiment plays a role of a search result output module which outputs, to the terminal 14, the search result received from the search system 12 in response to the output of the search query to the search system 12.

In the at least one embodiment, the search intermediation module 50 may output the search query to the target system in response to the reception of a search request for output of a predetermined chat message indicating that a search is executable (for example, reception of the chat message “Search for me” in response to the output of a chat message including the option image 26i on which the character string “Search for me” is arranged).

For example, in response to the first search intermediation module 50a determining that the information (context) sufficient for the execution of the search has been acquired, the chat message generation module 52 may generate a chat message including the option image 26i on which the character string “Search for me” is arranged. Then, the display control module 54 may transmit the chat screen 20 including the option image 26i to the terminal 14. After that, in response to reception of the chat message “Search for me” in response to the transmission of this chat screen 20, the search intermediation module 50 may generate the generated search query, calculate the search frequency score, and determine the at least one target system. Then, the search intermediation module 50 may output the generated search query having been generated to the at least one target system.

It is not required for the search intermediation module 50 to generate the generated search query in response to the reception of the search request in response to the output of the predetermined chat message indicating that the search can be executed, and to output the generated search query to the search system 12. Even in a situation in which the predetermined chat message indicating that the search can be executed is not output, in response to the reception of the search request, the search intermediation module 50 may generate the generated search query, and may output the generated search query to the search system 12. For example, in response to the reception module 42 receiving a message including a predetermined character string (for example, the “ [symbol] (Search for . . . )” character string in Japanese), the search intermediation module 50 may generate the generated search query, and may output the generated search query having been generated to the search system 12.

In the at least one embodiment, for example, the search result screen generation module 56 generates search result screen data indicating the search result of the search by the at least one target system. In the at least one embodiment, for example, the search result screen data including the tab 34a associated with all search results, the tabs 34 each associated with the relevant target system, the search result detail image 36a showing all search results, and the search result detail images 36 each showing the search result obtained by the search executed in the target system is generated.

Here, for example, it is assumed that the first search system 12a and the second search system 12b are the target systems. In this case, the search result screen data including the tab 34a, the tab 34b, the tab 34c, the search result detail image 36a, the search result detail image 36b, and the search result detail image 36c is generated. Here, the search result detail image 36b may show some of the search results obtained by the search executed in the first search system 12a. Moreover, the search result detail image 36c may show some of the search results obtained by the search executed in the second search system 12b. Further, the search result detail image 36a may show some of the search results obtained by the search executed in the first search system 12a shown in the search result detail image 36b and some of the search results obtained by the search executed in the second search system 12b shown in the search result detail image 36c.

Moreover, in the at least one embodiment, for example, the display control module 54 displays the search result screen 32 showing the search result received from each of the at least one target system.

The display control module 54 may generate, for example, in response to the reception of the search result display request from the terminal 14 by the reception module 42, the above-mentioned search result screen data, and may transmit this search result screen data to the terminal 14. Then, the terminal 14 may display, in response to the reception of this search result screen data, the search result screen 32a on the display of the terminal 14.

In the at least one embodiment, the prompt generation module 44 may store the prompt generated by the prompt generation module 44 in the log storage module 40. Moreover, the display control module 54 may store the chat screen 20 generated by the display control module 54 in the log storage module 40.

Moreover, in the at least one embodiment, the search intermediation module 50 may store the generated search query generated by the search intermediation module 50 in the log storage module 40.

Moreover, in the at least one embodiment, the log stored in the log storage module 40 may include the search result obtained by the search. For example, the search intermediation module 50 may store, in the log storage module 40, the search result received by the search intermediation module 50 from the target system. Moreover, the log stored in the log storage module 40 may include the history of the queries used for the search executed by the search system 12 which is collected by the executed query history collection module 48.

Moreover, the various types of data stored in the log storage module 40 as described above may be referred to in the above-mentioned various types of processing.

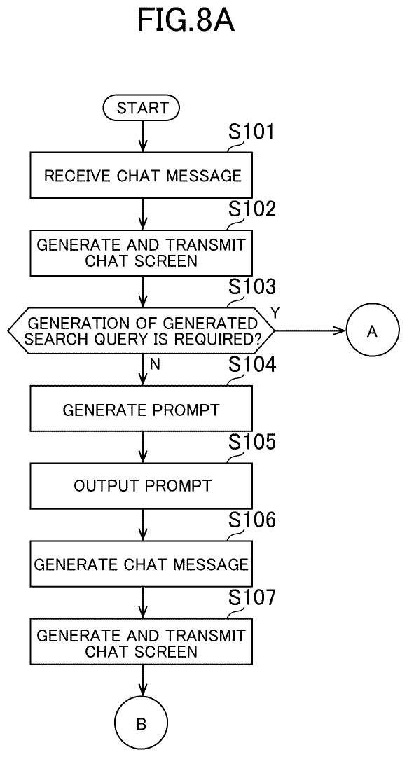

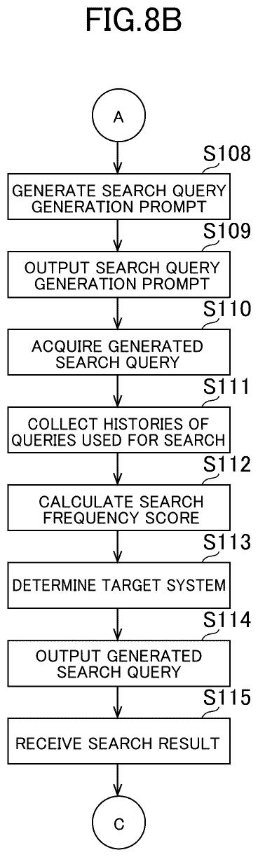

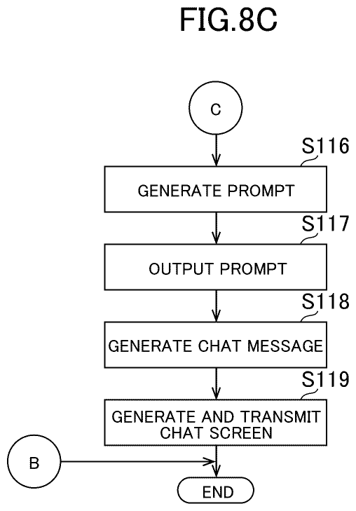

With reference to flowcharts exemplified in FIG. 8A, FIG. 8B, and FIG. 8C, description is now given of an example of a flow of processing executed in response to reception of a chat message in the search control system 10 according to the at least one embodiment.

When the reception module 42 receives a chat message from the terminal 14 (Step S101), the display control module 54 generates the chat screen 20 including this chat message, and transmits this chat screen 20 to the terminal 14 (Step S102). The terminal 14 updates, in response to the reception of the chat screen 20, the chat screen 20 displayed on the display to the received chat screen 20.

Then, the prompt generation module 44 determines, based on the chat message received in the processing step of Step S101, whether or not the generation of a generated search query is required (Step S103).

When it is determined that the generation of a generated search query is not required (N in Step S103), the prompt generation module 44 generates a prompt including the chat message received in the processing step of Step S101 (Step S104), and the prompt output module 46 outputs the prompt generated in the processing step of Step S104 to the intermediation LLM (Step S105).

Then, the chat message generation module 52 generates a chat message based on an answer being the output from the target model in response to the prompt output to the intermediation LLM in the processing step of Step S105 (Step S106).

Then, the display control module 54 generates the chat screen 20 including the chat message generated in the processing step of Step S106, and transmits this chat screen 20 to the terminal 14 (Step S107). After that, the processing in this processing example is finished. The terminal 14 updates, in response to the reception of the chat screen 20, the chat screen 20 displayed on the display to the received chat screen 20.

When it is determined that the generation of a generated search query is required in the processing step of Step S103 (Y in Step S103), the prompt generation module 44 generates a search query generation prompt (Step S108). The prompt output module 46 outputs, to the intermediation LLM, the search query generation prompt generated in the processing step of Step S108 (Step S109).

Then, the search intermediation module 50 acquires a generated search query being the output from the intermediation LLM in response to the search query generation prompt output to the intermediation LLM in the processing step of Step S109 (Step S110).

Then, the search intermediation module 50 outputs the collection instruction to the executed query history collection module 48, and the executed query history collection module 48 collects, from each of the first search system 12a, the second search system 12b, the third search system 12c, . . . , the history of the queries used for the search executed by this search system 12 (Step S111).

Then, the search intermediation module 50 calculates the search frequency score for each of the plurality of search system 12 based on the generated search query acquired in the processing step of Step S110 and the history of the queries collected in the processing step of Step S111 (Step S112).

Then, the search intermediation module 50 determines at least one target system based on the search frequency score of each of the plurality of search systems 12 calculated in the processing step of Step S112 (Step S113).

Then, the search intermediation module 50 outputs the generated search query acquired in the processing step of Step S110 to each of the at least one target system determined in the processing step of Step S113 (Step S114).

Then, the search intermediation module 50 receives a search result output from each of the at least one target system in response to the output of the generated search query to this target system (Step S115).

Then, the prompt generation module 44 generates a prompt including the search result received in the processing step of Step S115 (Step S116), and the prompt output module 46 outputs the prompt generated in the processing step of Step S116 to the intermediation LLM (Step S117).

Then, the chat message generation module 52 generates a chat message based on the search result received in the processing step of Step S115 and an answer being the output from the target model in response to the prompt output to the target model in the processing step of Step S117 (Step S118).

Then, the display control module 54 generates the chat screen 20 including the chat message generated in the processing step of Step S118, and transmits this chat screen 20 to the terminal 14 (Step S119). After that, the processing in this processing example is finished. The terminal 14 updates, in response to the reception of the chat screen 20, the chat screen 20 displayed on the display to the received chat screen 20.

The processing steps of Step S101 to Step S119 are executed each time the reception module 42 receives the chat message.

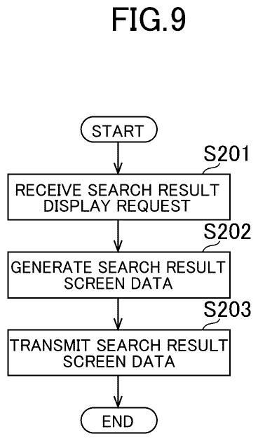

With reference to a flowchart exemplified in FIG. 9, description is next given of an example of a flow of processing executed in response to reception of a search result display request in the search control system 10 according to the at least one embodiment.

When the reception module 42 receives a search result display request from the terminal 14 (Step S201), the search result screen generation module 56 generates search result screen data based on the search result received in the processing step of Step S115 (Step S202).

Then, the display control module 54 transmits the search result screen data generated in the processing step of Step S202 to the terminal 14 (Step S203), and the processing in this processing example is finished. The terminal 14 may display, in response to the reception of this search result screen data, the search result screen 32 on the display.

According to the at least one embodiment, as described above, the user can seamlessly acquire the search result obtained by the search system 12 in such a sense that the user is naturally chatting a human through the chat screen 20.

Moreover, according to the at least one embodiment, as described above, the user can acquire the search result obtained by the search system 12 appropriate for a desired search without paying attention to the existence of the plurality of search systems 12.

In the at least one embodiment, the display control module 54 may display the search result screen 32 showing as many search results of each of the at least one target system as a search result presentation number corresponding to the search frequency score of this target system. For example, the search frequency score and the search result presentation number may be associated with each other in advance. Moreover, the search result screen generation module 56 may generate, for each of the at least one target system, the search result screen data including as many search results of this target system as the search result presentation number associated with the search frequency score of this target system.

Moreover, for example, the search result screen generation module 56 may determine, based on the search frequency score of each of the at least one target system, the search result presentation number associated with each of the at least one target system. For example, for each of the at least one target system, a number obtained by multiplying a predetermined number by the search frequency score of this target system and then dividing the product of this multiplication by a sum of the search frequency scores of the plurality of search systems 12 may be determined as the search result presentation number of this target system. Then, the search result screen generation module 56 may generate, for each of the at least one target system, the search result screen data including as many search results of this target system as the search result presentation number of this target system. After that, the display control module 54 may display the search result screen 32a showing as many search results of each of the at least one target system as the search result presentation number associated with this target system.

Here, for example, the search result screen 32a showing search results selected in accordance with a predetermined rule may be displayed. For example, the search result screen 32a showing as many search results as the search result presentation number in ascending order of the price may be displayed. As another example, for example, the search result screen 32a showing as many search results as the search result presentation number in reverse chronological order of day of start of sale may be displayed.

Moreover, in the at least one embodiment, each of the plurality of search systems 12 may be associated with a service. For example, the first search system 12a may be associated with an e-commerce service, and the second search system 12b may be associated with a second-hand product distribution service. Moreover, the search intermediation module 50 may determine at least one target system further based on a history of use (for example, a frequency of use) of the service associated with each of the plurality of search systems 12 by the user who uses the terminal 14. For example, when it is determined based on the history of use of each service that the e-commerce service has the highest frequency of use, the first search system 12a may be determined as the target system.

It should be noted that the present invention is not limited to the above-mentioned at least one embodiment.

For example, the language model in the at least one embodiment is not required to be the large language model (LLM). For example, the language model in the at least one embodiment may be an n-gram model, a recurrent neural network (RNN), a Seq2Seq model, a word embedding model, or the like.

Moreover, the search target of the search in the search system 12 in the at least one embodiment is not limited to a product and a service.

Moreover, the intermediation LLM may be, instead of being included in the search control system 10, included in an external system capable of communicating to and from the search control system 10.

Further, the specific character strings and numerical values described above and the specific character strings and numerical values in the drawings are merely exemplary, and the present invention is not limited to those character strings and numerical values.

Moreover, for example, the search control system may have the following configurations.
[1]

A search control system, including:
target system determination means for determining, based on a given search query and a history of a query used for a search executed by each of a plurality of search systems, at least one target system from the plurality of search systems;
search query output means for outputting the given search query to each of the at least one target system;
search result reception means for receiving a search result in response to the given search query from the each of the at least one target system; and
display control means for displaying a screen showing the search result received from the each of the at least one target system.
[2]

The search control system according to Item [1], further including search frequency score calculation means for calculating, based on the given search query and a history of a query used for a search executed by the each of the plurality of search systems, a search frequency score of the each of the plurality of search systems,
wherein the target system determination means is configured to determine the at least one target system based on the search frequency score.
[3]

The search control system according to Item [2], wherein the search frequency score calculation means is configured to calculate, based on a number of times of use of the given search query for a search executed by the each of the plurality of search systems, the search frequency score of the each of the plurality of search systems.
[4]

The search control system according to Item [2], wherein the search frequency score calculation means is configured to calculate, based on a ratio of a number of times of execution of a search that uses the given search query to a total number of searches executed by the each of the plurality of search systems, the search frequency score of the each of the plurality of search systems.
[5]

The search control system according to Item [2], wherein the target system determination means is configured to determine, as the at least one target system, at least one search system having the search frequency score higher than a predetermined value.
[6]

The search control system according to any one of Items [2] to [5], wherein the display control means is configured to display the screen showing as many search results of each of the at least one target system as a search result presentation number corresponding to the search frequency score of the each of the at least one target system.
[7]

The search control system according to any one of Items [2] to [5], further including search result presentation number determination means for determining, based on the search frequency score of each of the at least one target system, a search result presentation number associated with the each of the at least one target system,
wherein the display control means is configured to display the screen showing as many search results of each of the at least one target system as the search result presentation number associated with the each of the at least one target system.
[8]

The search control system according to any one of Items [1] to [7], further including search query generation means for generating the given search query based on a received chat message in response to satisfaction of a given condition,
wherein the target system determination means is configured to determine the at least one target system based on the generated given search query.
[9]

The search control system according to any one of Items [1] to [7], further including:
prompt generation means for generating, based on a chat message received from a terminal, a prompt to be output to a language model;
prompt output means for outputting the prompt to the language model;
chat message output means for outputting, to the terminal, a chat message based on an answer from the language model in response to the prompt; and
search query generation means for generating the given search query based on a log related to exchange of a chat message with the terminal in response to satisfaction of a given condition,
wherein the target system determination means is configured to determine the at least one target system based on the generated given search query, and
wherein the display control means is configured to display the screen on the terminal.
[10]

The search control system according to Item [9], wherein the history is a history of a query used for a search executed in response to a request from a user who uses the terminal.
[11]

The search control system according to Item [9] or [10],
wherein each of the plurality of search systems is associated with a service, and
wherein the target system determination means is configured to determine the at least one target system further based on a history of use of the service associated with the each of the plurality of search systems by a user who uses the terminal.
[12]

The search control system according to any one of Items [9] to [11], further including the terminal,
wherein the terminal includes display means for displaying the screen.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A search control system, comprising:
at least one processor; and
at least one memory device storing instructions which, when executed by the at least one processor, cause the at least one processor to perform operations comprising:
determining, based on a given search query and a history of a query used for a search executed by each of a plurality of search systems, at least one target system from the plurality of search systems;
outputting the given search query to each of the at least one target system;
receiving a search result in response to the given search query from the each of the at least one target system; and
displaying a screen showing the search result received from the each of the at least one target system.

2. The search control system according to claim 1,
wherein the operations further comprise calculating, based on the given search query and a history of a query used for a search executed by the each of the plurality of search systems, a search frequency score of the each of the plurality of search systems, and
wherein the determining the at least one target system includes determining the at least one target system based on the search frequency score.

3. The search control system according to claim 2, wherein the calculating the search frequency score includes calculating, based on a number of times of use of the given search query for a search executed by the each of the plurality of search systems, the search frequency score of the each of the plurality of search systems.

4. The search control system according to claim 2, wherein the calculating of the search frequency score includes calculating, based on a ratio of a number of times of execution of a search that uses the given search query to a total number of searches executed by the each of the plurality of search systems, the search frequency score of the each of the plurality of search systems.

5. The search control system according to claim 2, wherein the determining the at least one target system includes determining, as the at least one target system, at least one search system having the search frequency score higher than a predetermined value.

6. The search control system according to claim 2, wherein the displaying the screen includes displaying the screen showing as many search results of each of the at least one target system as a search result presentation number corresponding to the search frequency score of the each of the at least one target system.

7. The search control system according to claim 2,
wherein the operations further comprise determining, based on the search frequency score of each of the at least one target system, a search result presentation number associated with the each of the at least one target system, and
wherein the displaying the screen includes displaying the screen showing as many search results of each of the at least one target system as the search result presentation number associated with the each of the at least one target system.

8. The search control system according to claim 1,
wherein the operations further comprise generating the given search query based on a received chat message in response to satisfaction of a given condition, and
wherein the determining the at least one target system includes determining the at least one target system based on the generated given search query.

9. The search control system according to claim 1,
wherein the operations further comprise:
generating, based on a chat message received from a terminal, a prompt to be output to a language model;
outputting the prompt to the language model;
outputting, to the terminal, a chat message based on an answer from the language model in response to the prompt; and
generating the given search query based on a log related to exchange of a chat message with the terminal in response to satisfaction of a given condition, and
wherein the determining the at least one target system includes determining the at least one target system based on the generated given search query, and
wherein the displaying the screen includes displaying the screen on the terminal.

10. The search control system according to claim 9, wherein the history is a history of a query used for a search executed in response to a request from a user who uses the terminal.

11. The search control system according to claim 9,
wherein each of the plurality of search systems is associated with a service, and
wherein the determining the at least one target system includes determining the at least one target system further based on a history of use of the service associated with the each of the plurality of search systems by a user who uses the terminal.

12. The search control system according to claim 9, further comprising the terminal,
wherein the terminal includes a display configured to display the screen.

13. A search control method, comprising:
determining, based on a given search query and a history of a query used for a search executed by each of a plurality of search systems, at least one target system from the plurality of search systems;
outputting the given search query to each of the at least one target system;
receiving a search result in response to the given search query from the each of the at least one target system; and
displaying a screen showing the search result received from the each of the at least one target system.

14. A non-transitory computer readable information storage medium storing a program that causes a computer to execute:
determining, based on a given search query and a history of a query used for a search executed by each of a plurality of search systems, at least one target system from the plurality of search systems;
outputting the given search query to each of the at least one target system;
receiving a search result in response to the given search query from the each of the at least one target system; and
displaying a screen showing the search result received from the each of the at least one target system.
